(19) United States
(12) Patent Application Publication
(10) Pub. No.: US 2022/0386634 A1
(43) Pub. Date: Dec. 8, 2022

(54) METHOD FOR PROLONGING SHELF LIFE OF FROZEN AQUATIC PRODUCTS

(71) Applicant: ZHEJIANG OCEAN UNIVERSITY, ZHOUSHAN (CN)

(72) Inventors: SHANGGUI DENG, ZHOUSHAN (CN); XIAOGUO YING, ZHOUSHAN (CN)

(21) Appl. No.: 17/741,451

(22) Filed: May 11, 2022

Related U.S. Application Data
(63) Continuation of application No. PCT/CN2021/108318, filed on Jul. 26, 2021.

(30) Foreign Application Priority Data
Jun. 8, 2021 (CN) 202110637535X

(51) Int. Cl. A23B 4/015; A23B 4/10; A23B 4/16

(52) U.S. Cl. CPC A23B 4/015; A23B 4/10; A23B 4/16

(57) ABSTRACT

A compound and a method for prolonging shelf life of frozen aquatic products are provided. The compound includes: 15-20 parts by weight of modified carboxymethyl chitosan, 5-12 parts by weight of pectin, 2-5 parts by weight of oleic acid, 1-3 parts by weight of yeast selenium, 1-3 parts by weight of natamycin and 2-6 parts by weight of nisin. The method includes sequentially treating a frozen aquatic product under a mixed gas and soaking the frozen aquatic product in the compound. The method can obviously slow down the degradation and oxidative denaturation of protein in aquatic products during cold storage, thus effectively maintaining the activity of protein in the aquatic products and slowing down the deterioration of the aquatic products.

### CROSS-REFERENCE TO RELATED APPLICATION

This application claims priority to Chinese Patent Application No. 202110637535.X, filed on Jun. 8, 2021, the contents of which are hereby incorporated by reference.

### TECHNICAL FIELD

The disclosure relates to the field of food preservation, and in particular to a method for prolonging shelf life of frozen aquatic products.

### BACKGROUND

China ranks first in the world in terms of aquaculture, fishery production and aquatic product trade with huge production and consumption of aquatic products; in 2019, the country's overall fishery production was 64,803,600 tonnes with a total fishery gross output value of 2,640,650 million yuan and a national per capita fishery share of 46.45 kg (the country's population was 1,395,380,000 then). Currently one of the most widely utilized aquatic raw materials in China is squid, also known as soft fish or calamary, which are a cephalopod belonging to the Oegopsida, Teuthida in the Cephalopoda class. Squid is one of the underutilized marine fishery resources in the world with great potential; they are rich in nutrients, containing about 17% protein and about 13% fat. However, squids are prone to spoilage due to the presence of many enzymes that degrade nutrients, as well as a high water content and tender muscle tissues, which are particularly suitable for microbes to grow and reproduce; moreover, there has been a dynamic change in the structure of squid production, with a decreasing trend in the production of previously economically important squid species such as Argentine shortfin squid (Illex argentines) and neon flying squid (Ommastrephes bartrami). Therefore, by controlling enzyme activities and microbial growth and reproduction, it is not only beneficial to improve the utilisation of squid resources and reduce economic losses, but also conducive to deliver squids of good quality with guaranteed supply.

For a long time, people freeze aquatic products to prolong the shelf life; in this way, although aquatic products are preserved for a long time, the meat, flavors, textures, water-holding capacity and nutritional qualities of the products are greatly impaired during the process of freezing, storage and thawing. Besides, drying, salting and smoking methods in addition to freezing are also resorted to, all of which have a significant impact on the quality of aquatic products and may also contain chemical components detrimental to human health, despite the extended shelf life of aquatic products. In line with the progress of science and technology and the increasing consumer demand for food quality, there is an urgent need for a new preservation method that is safe, harmless and maintains the original quality of aquatic products so as to improve the quality and shelf life of aquatic products.

### SUMMARY

It is an objective of the disclosure to provide a method for prolonging shelf life of frozen aquatic products to solve the above-mentioned problems of the prior art. Aquatic products are treated with a gas mixture under low temperature plasma conditions and then treated with a formulated compound to extend the shelf life of frozen aquatic products, thus significantly reducing the degradation and oxidative denaturation of aquatic proteins during refrigeration, effectively maintaining the protein activity in aquatic products and slowing down the deterioration of aquatic product quality.

To achieve the above objective, the disclosure provides the following technical solution.

The disclosure provides a compound for prolonging the shelf life of frozen aquatic products, which includes the following components in parts by weight: 15-20 parts of modified carboxymethyl chitosan, 5-12 parts of pectin, 2-5 parts of oleic acid, 1-3 parts of yeast selenium, 1-3 parts of natamycin and 2-6 parts of nisin.

In an embodiment, the compound includes the following components in parts by weight: 18-20 parts of modified carboxymethyl chitosan, 8-10 parts of pectin, 2-3 parts of oleic acid, 1-2 parts of yeast selenium, 1-2 parts of natamycin and 2-4 parts of nisin.

In an embodiment, the compound includes the following components in parts by weight: 19 parts of modified carboxymethyl chitosan, 8.5 parts of pectin, 2.5 parts of oleic acid, 1.2 parts of yeast selenium, 1.5 parts of natamycin and 3.5 parts of nisin.

The disclosure further provides a method for preparing the compound for prolonging shelf life of frozen aquatic products, which includes the following steps:

S1, preparing modified carboxymethyl chitosan, where the modified carboxymethyl chitosan is obtained by mixing carboxymethyl chitosan and L-cysteine hydrochloride according to a mass ratio of 1:1-1.5, followed by shaking at room temperature for 2-3 hours (h); and

S2, mixing pectin, oleic acid and the modified carboxymethyl chitosan obtained in S1 according to the ratio of components of the compound, stirring at high speed for 2-3 h; adding yeast selenium, natamycin and nisin, and stirring at low speed for 30-60 minutes (min) to obtain the compound.

In an embodiment, the high-speed stirring refers to a rotating speed of 5,000-8,000 round per minute (rpm), and the low-speed stirring refers to a rotating speed of 300-500 rpm.

The disclosure further provides a method for prolonging the shelf life of frozen aquatic products by using the compound, which includes the steps of sequentially treating frozen products by using mixed gases and soaking the frozen products by using the compound.

In an embodiment, the method specifically includes the following steps: firstly, treating the frozen product with low-temperature plasma beam in a mixed gas composed of 55% carbon dioxide (CO₂), 25% nitrogen (N₂) and 20% oxygen (O₂) for 20-30 seconds (s); then, soaking the frozen products in the compound and ultrasonically treating the frozen product for 10-15 min, taking out, standing for 1-2 min, and storing in a refrigerator at 4° C.

In an embodiment, the low-temperature plasma beam has a voltage of 50-60 kilovolt (kV).

In an embodiment, the frozen product is a fish product.

The disclosure discloses the following technical effects:

the compound for prolonging shelf life of frozen aquatic products prepared by the disclosure includes modified carboxymethyl chitosan, pectin, oleic acid, yeast selenium, natamycin and nisin. Among them, carboxymethyl chitosan modified by L-cysteine has good film forming property; pectin shows good cross-linking performance when added to modified carboxymethyl chitosan and enhances film ductility due to its complex structure formed by a large number of interlocking main chains and branched chains; oleic acid enhances the softness of the film and the water repellency in addition to inhibiting absorbing water outside the film or evaporation inside the film; yeast selenium not only provides selenium to enhance nutritional elements, but also promotes activating antioxidant enzymes in aquatic products, and inhibits lipid peroxidation as well as improves antioxidant properties so as to facilitate extending shelf life of aquatic products, and natamycin and lactic acid streptococcus can effectively prevent fungal and bacterial invasion and infection; the ingredients used in the above-mentioned compound are food-grade and therefore do not affect the consumption of the aquatic products after soaking.

By first treating aquatic products briefly with low temperature plasma in a mixture of CO₂, N₂ and O₂, the disclosure is able to control the increase in t. tazv. zatilebasienitr. gen (TVB-N) values better than without low temperature plasma treatment due to the ionisation-generated ultraviolet light (UV) radiation inducing deoxyriboNucleic acid (DNA) damage in microorganisms, coupled with the rapid death of microorganisms caused by the combined synergistic effect of multiple plasma active substances produced by low temperature plasma, which in turn can achieve the effect of sterilisation and extended storage time; in addition, after the low temperature plasma treatment in the mixed gas, it is also necessary to soak the aquatic products with the compound prepared by the disclosure so as to form a film on the surface of aquatic products; the film is not only edible, but also enhances water retention and the content of selenium element as well as antioxidant capacity; the film can also inhibit the pollution of exotic bacteria and fungi in the environment during storage so as to realize double bacteriostatic protection before and after storage, thus can prolong the preservation period by 3-5 days, and greatly retain the original quality of aquatic products.

### DETAILED DESCRIPTION OF THE EMBODIMENTS

Now various exemplary embodiments of the disclosure will be described in detail. This detailed description should not be taken as a limitation of the disclosure, but should be understood as a more detailed description of some aspects, characteristics and embodiments of the disclosure.

It should be understood that the terms mentioned in the disclosure are only used to describe specific embodiments, and are not used to limit the disclosure. In addition, for the numerical range in the disclosure, it should be understood that each intermediate value between the upper limit and the lower limit of the range is also specifically disclosed. Every smaller range between any stated value or the intermediate value within the stated range and any other stated value or the intermediate value within the stated range is also included in the disclosure. The upper and lower limits of these smaller ranges can be independently included or excluded from the range.

Unless otherwise stated, all technical and scientific terms used herein have the same meanings commonly understood by those skilled in the art. Although the disclosure only describes preferred methods and materials, any methods and materials similar or equivalent to those described herein can be used in the practice or testing of the disclosure. All documents mentioned in this specification are incorporated by reference to disclose and describe the methods and/or materials related to the documents. In case of conflict with any incorporated documents, the content of this specification shall prevail.

Without departing from the scope or spirit of the disclosure, it is obvious to those skilled in the art that many modifications and changes can be made to the specific embodiments of the specification. Other embodiments obtained from the description of the disclosure will be obvious to those skilled in the art. The specification and embodiment of this disclosure are only exemplary.

As used in this paper, the terms “comprising”, “including”, “having” and “containing” are all open terms, meaning including but not limited to.

### Embodiment 1

A compound for prolonging the shelf life of frozen aquatic products includes the following components in parts by weight: 15 parts of modified carboxymethyl chitosan, 5 parts of pectin, 2 parts of oleic acid, 1 part of yeast selenium, 1 part of natamycin and 2 parts of nisin.

A method for preparing the compound for prolonging the shelf life of frozen aquatic products comprises the following steps:

S1, preparing modified carboxymethyl chitosan, where the modified carboxymethyl chitosan is obtained by mixing carboxymethyl chitosan and L-cysteine hydrochloride according to a mass ratio of 1:1, followed by shaking at room temperature for 2 hours (h); and

S2, mixing pectin, oleic acid and the modified carboxymethyl chitosan obtained in S1 according to the ratio of the components of the compound, stirring at high speed of 5,000 rpm for 2 h; adding yeast selenium, natamycin and nisin, and stirring at low speed of 300 rpm for 30 min to obtain a compound.

### Embodiment 2

A compound for prolonging shelf life of frozen aquatic products includes the following components in parts by weight: 19 parts of modified carboxymethyl chitosan, 8.5 parts of pectin, 2.5 parts of oleic acid, 1.2 parts of yeast selenium, 1.5 parts of natamycin and 3.5 parts of nisin.

A method for preparing the compound for prolonging shelf life of frozen aquatic products includes the following steps:

S1, preparing modified carboxymethyl chitosan, where the modified carboxymethyl chitosan is obtained by mixing carboxymethyl chitosan and L-cysteine hydrochloride according to a mass ratio of 1:1.2, followed by shaking at room temperature for 2.5 h; and

S2, mixing pectin, oleic acid and the modified carboxymethyl chitosan obtained in S1 of this embodiment according to the ratio of components of the compound, stirring at high speed of 6,000 rpm for 2.5 h; adding yeast selenium, natamycin and nisin, and stirring at low speed of 400 rpm for 45 min to obtain a compound.

### Embodiment 3

A compound for prolonging shelf life of frozen aquatic products includes the following components in parts by weight: 20 parts of modified carboxymethyl chitosan, 12 parts of pectin, 5 parts of oleic acid, 3 parts of yeast selenium, 3 parts of natamycin and 6 parts of nisin.

A method for preparing the compound for prolonging shelf life of frozen aquatic products includes the following steps:

S1, preparing modified carboxymethyl chitosan, where the modified carboxymethyl chitosan is obtained by mixing carboxymethyl chitosan and L-cysteine hydrochloride according to a mass ratio of 1:1.5, followed by shaking at room temperature for 3 h; and

S2, mixing pectin, oleic acid and the modified carboxymethyl chitosan obtained in S1 of this embodiment according to the ratio of components of the compound, stirring at high speed of 8,000 rpm for 3 h; adding yeast selenium, natamycin and nisin, and stirring at low speed of 500 rpm for 60 min to obtain a compound.

### Comparative Embodiment 1

This comparative embodiment differs from Embodiment 2 in that pectin is not added to the compound, and other steps are the same.

### Comparative Embodiment 2

This comparative embodiment differs from Embodiment 2 in that oleic acid is not added in the compound, and other steps are the same.

### Comparative Embodiment 3

This comparative embodiment differs from Embodiment 2 in that yeast selenium is not added in the compound, and other steps are the same.

### Comparative Embodiment 4

This comparative embodiment differs from Embodiment 2 in that natamycin and nisin are not added in the compound, and other steps are the same.

Experiment 1

1. Materials

Humboldt squid (Dosidicus gigas), about 300 millimeter (mm) in length and 1,000 gram (g) in weight, is purchased in Zhoushan Aquatic Products Town, Zhejiang Province, China. The fresh squid samples are placed in an incubator filled with ice and transported back to the laboratory within 30 min for later use.

2. Squid Preservation Methods

The squid is peeled and eviscerated, cut into squid slices with length, width and height of 3 centimeter (cm)×3 cm×1 cm along the body axis, and treated with low-temperature plasma beam for 30 s in a mixed gas of 55% CO₂, 25% N₂ and 20% O₂. Then, the compounds prepared in Embodiments 1-3 and Comparative embodiments 1-4 are used to soak and ultrasonically treat the frozen product for 10 min, and then the frozen products are taken out and stood for 1 min, and stored in a refrigerator at 4° C. At the same time, on the basis of Embodiment 2, the samples without low-temperature plasma treatment and the samples without compound soaking treatment are respectively used as control 1 and control 2, and the samples with 0.5% sodium sulfite chemical preservative and samples without any treatment are used as control 3 and control 4, respectively. The total bacterial count (determination method with reference to GB/T 4789.2) and TVB-N (determination method with reference to GB 2733-2015) of the samples are measured at 0^{th} day (d), 5^{th} d, 10^{th} d and 15^{th} d respectively.

TABLE 1
Determination results of total bacteria of different samples

| Sample | 0^{th} d | 5^{th} d | 10^{th} d | 15^{th} d |
|---|---|---|---|---|
| Embodiment 1 | 4.35 | 4.46 | 6.57 | 6.90 |
| Embodiment 2 | 4.35 | 4.40 | 6.50 | 6.89 |
| Embodiment 3 | 4.35 | 4.50 | 6.60 | 6.93 |
| Comparative embodiment 1 | 4.35 | 4.56 | 6.70 | 7.35 |
| Comparative embodiment 2 | 4.35 | 4.55 | 6.72 | 7.35 |
| Comparative embodiment 3 | 4.35 | 4.55 | 6.70 | 7.37 |
| Comparative embodiment 4 | 4.35 | 5.06 | 7.58 | 8.01 |
| Control 1 | 4.35 | 5.98 | 8.60 | 9.65 |
| Control 2 | 4.35 | 5.96 | 8.63 | 9.70 |
| Control 3 | 4.35 | 5.78 | 7.26 | 9.05 |
| Control 4 | 4.35 | 6.01 | 9.01 | 10.99 |

TABLE 2
Determination results of TVB-N of different samples

| Sample | 0^{th} d | 5^{th} d | 10^{th} d | 15^{th} d |
|---|---|---|---|---|
| Embodiment 1 | 5.40 | 8.80 | 19.60 | 31.69 |
| Embodiment 2 | 5.40 | 8.86 | 19.53 | 31.55 |
| Embodiment 3 | 5.40 | 8.81 | 19.62 | 31.60 |
| Comparative embodiment 1 | 5.40 | 9.63 | 23.65 | 38.60 |
| Comparative embodiment 2 | 5.40 | 9.68 | 24.02 | 38.67 |
| Comparative embodiment 3 | 5.40 | 9.65 | 23.72 | 38.68 |
| Comparative embodiment 4 | 5.40 | 10.02 | 24.22 | 38.77 |
| Control 1 | 5.40 | 20.01 | 30.56 | 35.56 |
| Control 2 | 5.40 | 20.08 | 30.68 | 35.36 |
| Control 3 | 5.40 | 18.31 | 38.68 | 60.02 |
| Control 4 | 5.40 | 47.03 | 40.12 | — |

As can be seen from Table 1 and Table 2, the compounds prepared in Embodiments 1-3 and low-temperature plasma have obvious effects on the preservation of squid; there is a significant inhibition of the growth of the total bacterial count as well as an increase in the freshness of the squid after treatment with low temperature plasma and compound, with shelf life extended by 3-5 days.

In addition, the squid colour, smell and muscle elasticity at day 15 of the preservation are also measured. 20 people are involved in the assessment, and the scoring criteria and results are shown in Tables 3 and 4.

TABLE 3
Criteria for sensory evaluation of squid

| | | | Elasticity |
|---|---|---|---|
| Score | Colour and lustre | Smell | of muscle |
| 5 points | Normal colour and | Inherent fragrance | Firm and elastic, |
| | lustre on muscle | of the variety, | depressions |
| | section | fresh | disappear |
| | | | immediately |
| | | | after index |
| | | | finger pressure |
| 4 points | Normal colour and | Inherent fragrance, | Firm and elastic, |
| | slight lustre on | fresh | depressions |
| | muscle section | | disappear |
| | | | relatively |
| | | | quickly after |
| | | | index finger |
| | | | pressure |
| 3 points | Slightly dull color, | Inherent fragrance, | Relatively elastic, |
| | slightly lustre on | light, slightly | depressions |
| | the muscle section | peculiar smell | disappear rather |
| | | | slowly after |
| | | | index finger |
| | | | pressure |
| 2 points | Relative dull color | Loss of inherent | Slightly elastic, |
| | and no lustre on | fragrance and a | indentation |
| | the muscle section | fishy or | disappears |
| | | ammoniacal odour | very slowly |
| | | | after index |
| | | | finger pressure |
| 1 point | dull color and no | Strong fishy or | No elasticity, |
| | lustre on the | ammoniacal odour | depression |
| | muscle section | | does not |
| | | | disappear |
| | | | after index |
| | | | finger pressure |

TABLE 4
Sensory score results of squid

| | Colour | | Elasticity |
|---|---|---|---|
| Sample | and lustre | Smell | of muscle |
| Embodiment 1 | 5 | 4 | 5 |
| Embodiment 2 | 5 | 5 | 5 |
| Embodiment 3 | 5 | 5 | 4 |
| Comparative embodiment 1 | 5 | 3 | 3 |
| Comparative embodiment 2 | 4 | 3 | 3 |
| Comparative embodiment 3 | 3 | 4 | 3 |
| Comparative embodiment 4 | 4 | 2 | 3 |
| Control 1 | 4 | 4 | 3 |
| Control 2 | 3 | 3 | 4 |
| Control 3 | 3 | 3 | 2 |
| Control 4 | 2 | 2 | 1 |

As can be seen from Table 4, the freshness, texture and flavour of the squid can be ensured to the maximum extent possible within 15 days using the preservation method of the disclosure.

The above-mentioned embodiments only describe the preferred mode of the disclosure, but do not limit the scope of the disclosure. On the premise of not departing from the design spirit of the disclosure, all kinds of modifications and improvements made by those skilled in the art to the technical scheme of the disclosure shall fall within the scope of protection determined by the claims of the disclosure.

What is claimed is:

1. A compound for prolonging shelf life of frozen aquatic products, comprising following components in parts by weight:
15-20 parts by weight of modified carboxymethyl chitosan,
5-12 parts by weight of pectin,
2-5 parts by weight of oleic acid,
1-3 parts by weight of yeast selenium,
1-3 parts by weight of natamycin, and
2-6 parts by weight of nisin.

2. The compound for prolonging shelf life of frozen aquatic products according to claim 1, wherein the compound specifically comprises:
18-20 parts by weight of the modified carboxymethyl chitosan,
8-10 parts by weight of the pectin,
2-3 parts by weight of the oleic acid,
1-2 parts by weight of the yeast selenium,
1-2 parts by weight of the natamycin, and
2-4 parts by weight of the nisin.

3. The compound for prolonging shelf life of frozen aquatic products according to claim 2, wherein the compound specifically comprises:
19 parts by weight of the modified carboxymethyl chitosan,
8.5 parts by weight of the pectin,
2.5 parts by weight of the oleic acid,
1.2 parts by weight of the yeast selenium,
1.5 parts by weight of the natamycin, and
3.5 parts by weight of the nisin.

4. A method for preparing the compound for prolonging shelf life of frozen aquatic products according to claim 1, comprising:
S1, preparing the modified carboxymethyl chitosan: obtaining the modified carboxymethyl chitosan by mixing carboxymethyl chitosan and L-cysteine hydrochloride according to a mass ratio of 1:1-1.5, followed by shaking at room temperature for 2-3 hours (h); and
S2, mixing the pectin, the oleic acid and the modified carboxymethyl chitosan obtained in S1 according to a mixture ratio of the components of the compound with stirring at a high speed for 2-3 h; and then adding the yeast selenium, the natamycin and the nisin with stirring at a low speed for 30-60 minutes (min) to obtain the compound.

5. The method according to claim 4, wherein the high speed is in a range of 5,000 to 8,000 round per minute (rpm), and the low speed is in a range of 300 to 500 rpm.

6. A method for prolonging shelf life of frozen aquatic products, comprising:
treating a frozen aquatic product with a mixed gas; and
soaking the treated frozen aquatic product with the compound according to claim 1.

7. The method according to claim 6, wherein the treating a frozen aquatic product with a mixed gas, comprises: treating the frozen aquatic product with low-temperature plasma beam in the mixed gas including 55% CO₂, 25% N₂ and 20% O₂ for 20-30 seconds (s);
wherein soaking the treated frozen aquatic product with the compound according to claim 1, comprises:
soaking the treated frozen aquatic product in the compound and ultrasonically treating the treated frozen aquatic product for 10-15 min, taking out the treated frozen aquatic product after the ultrasonically treating to stand for 1-2 min, and then storing in a refrigerator at 4° C.

8. The method according to claim 7, wherein a voltage of the low-temperature plasma beam is in a range of 50 to 60 kilovolt (kV).

9. The method according to claim 6, wherein the frozen aquatic product is a fish product.
